(19) United States
(12) Patent Application Publication
(10) Pub. No.: US 2024/0371574 A1
(43) Pub. Date: Nov. 7, 2024

(54) CAPACITOR MODULE AND METHOD FOR FABRICATING CAPACITOR MODULE

(71) Applicant: Murata Manufacturing Co., Ltd., Nagaokakyo-shi (JP)

(72) Inventors: Satoru JOGAN, Nagaokakyo-shi (JP); Kouji TAKAGAKI, Nagaokakyo-shi (JP)

(21) Appl. No.: 18/773,852

(22) Filed: Jul. 16, 2024

Related U.S. Application Data
(63) Continuation of application No. PCT/JP2023/000020, filed on Jan. 4, 2023.

(30) Foreign Application Priority Data
Jan. 18, 2022 (JP) 2022-005991

(51) Int. Cl. H01G 4/38; H01G 4/228; H02G 5/02

(52) U.S. Cl. CPC H01G 4/38; H01G 4/228; H02G 5/02

(57) ABSTRACT

A capacitor module is provided that includes one or more capacitors that each include a main-body covered with a laminate film, and a first terminal electrode and a second terminal electrode exposed from the main-body. A case is provide with recesses for housing the one or more capacitors, a first bus bar integrally incorporated in the case and electrically connected to the first terminal electrodes, and a second bus bar integrally incorporated in the case and electrically connected to the second terminal electrodes. The first bus bar includes one or more first connection portions connected to the respective first terminal electrodes of the capacitors disposed in the recesses, and the second bus bar includes one or more second connection portions connected to the respective second terminal electrodes of the capacitors disposed in the recesses.

### CROSS REFERENCE TO RELATED APPLICATIONS

The present application is a continuation of PCT/JP2023/000020 filed Jan. 4, 2023, which claims priority to Japanese Patent Application No. 2022-005991, filed Jan. 18, 2022, the entire contents of each of which are incorporated herein by reference.

### TECHNICAL FIELD

The present disclosure relates to capacitor modules and methods for fabricating capacitor modules.

### BACKGROUND

Capacitors using laminate films as exterior covering materials are known. For example, Japanese Patent No. 4354240 describes a surface-mounted capacitor including a capacitor exteriorly-covered with a laminate film.

The surface-mounted capacitor described in Japanese Patent No. 4354240 has room for improvement in terms of insulation and size reduction when the capacitor is modularized.

### SUMMARY OF THE INVENTION

In view of the foregoing, the exemplary aspects of the present disclosure provide a capacitor module with improved insulation and a reduced size. Moreover, a method for fabricating the capacitor module is also described herein.

In an exemplary aspect, a capacitor module is provided that includes one or more capacitors that each comprise a main-body covered with a laminate film, and a first terminal electrode and a second terminal electrode exposed from the main-body; a case having one or more recesses that are adapted to house the one or more capacitors; a first bus bar integrally incorporated in the case and electrically connected to the first terminal electrodes; and a second bus bar integrally incorporated in the case and electrically connected to the second terminal electrodes. The first bus bar includes one or more first connection portions connected to the respective first terminal electrodes of the capacitors disposed in the recesses, and the second bus bar includes one or more second connection portions connected to the respective second terminal electrodes of the capacitors disposed in the recesses.

In another exemplary aspect, a method for fabricating a capacitor module is provided that includes preparing a case integrally incorporating a first bus bar and a second bus bar, the case being provided with a recess for housing a capacitor having a first terminal electrode and a second terminal electrode; disposing the capacitor in the recess in the case; and connecting the first bus bar and the first terminal electrode to each other, and connecting the second bus bar and the second terminal electrode to each other.

According to the exemplary aspects of the present disclosure, a capacitor module is provided with improved insulation and a reduced size. Moreover, a method is disclosed for fabricating the capacitor module.

### BRIEF DESCRIPTION OF THE DRAWINGS

FIG. 1 is a perspective view illustrating a capacitor module according to a first exemplary embodiment.

FIG. 2 is an exploded perspective view of the capacitor module in FIG. 1.

FIG. 3 is an exploded view of a case in the capacitor module in FIG. 1.

FIG. 4 is a perspective view illustrating a capacitor in the capacitor module in FIG. 1.

FIG. 5 is a cross-sectional view of the capacitor module taken along a line A-A in FIG. 1.

FIG. 6 is a cross-sectional view of the capacitor module taken along a line B-B in FIG. 1.

FIG. 7 is a flowchart illustrating a method for fabricating the capacitor module.

FIG. 8A is a view for explaining an exemplary process for fabricating the capacitor module.

FIG. 8B is a view for explaining an exemplary process for fabricating the capacitor module.

FIG. 8C is a view for explaining an exemplary process for fabricating the capacitor module.

FIG. 8D is a view for explaining an exemplary process for fabricating the capacitor module.

FIG. 9 is a perspective view illustrating a capacitor module according to a second exemplary embodiment.

FIG. 10 is an exploded perspective view of the capacitor module in FIG. 9.

FIG. 11 is an exploded view of a first case in the capacitor module in FIG. 9.

FIG. 12 is an exploded view of a second case in the capacitor module in FIG. 9.

FIG. 13 is a perspective view illustrating a capacitor in the capacitor module in FIG. 9.

FIG. 14 is a view of the capacitor module in FIG. 9, wherein the second case is omitted.

FIG. 15 is an enlarged cross-sectional view of a region RI taken along a line C-C in FIG. 14.

FIG. 16 is a flowchart illustrating a method for fabricating the capacitor module in FIG. 9.

FIG. 17 is a perspective view illustrating a capacitor module in a first modification example of the second exemplary embodiment.

FIG. 18 is an exploded perspective view of the capacitor module in FIG. 17.

FIG. 19 is an exploded view of a first case in the capacitor module in FIG. 17.

FIG. 20 is a flowchart illustrating a method for fabricating the capacitor module in FIG. 17.

### DETAILED DESCRIPTION

Currently, there are known film capacitors that use laminate films as materials for exteriorly covering capacitors. For example, Japanese Patent No. 4354240 discloses a surface-mounted capacitor that includes a capacitor having extraction leads and exteriorly covered with a laminate film, and a fixing plate including an external connection terminal.

The capacitor exteriorly covered with the laminate film is excellent in weather resistance and, therefore, there is no need for covering the entire capacitor with a resin. On the other hand, when the capacitor covered with the laminate film is connected to a bus bar and used as a capacitor module, there are problems of difficulty of securing insulation between terminal electrodes in the capacitor, and difficulty of protecting the portions of bonding between the terminal electrodes and the bus bar.

In view of the foregoing, a capacitor module is provided with improved insulation between terminal electrodes and that is configured for easily protecting the portions of bonding between the terminal electrodes and bus bars. Moreover, a method for fabricating the capacitor module is described herein.

According to an exemplary aspect, a capacitor module is provided that includes one or more capacitors each comprising a main-body covered with a laminate film, and a first terminal electrode and a second terminal electrode exposed from the main-body; a case that includes one or more recesses configured to house the one or more capacitors; a first bus bar integrally incorporated in the case and electrically connected to the first terminal electrodes; and a second bus bar integrally incorporated in the case and electrically connected to the second terminal electrodes. Moreover, the first bus bar includes one or more first connection portions connected to the respective first terminal electrodes of the one or more capacitors disposed in the recesses, and the second bus bar includes one or more second connection portions connected to the respective second terminal electrodes of the one or more capacitors disposed in the recesses.

With this configuration, a small-sized capacitor module is provided while securing insulation between the first bus bar and the second bus bar.

In the capacitor module in a second exemplary aspect, each of the one or more recesses may include a first recess for disposing the main-body, a second recess for disposing the first terminal electrode, and a third recess for disposing the second terminal electrode. Moreover, the first connection portions may be positioned in the second recesses, and the second connection portions may be positioned in the third recesses.

With this configuration, the capacitors can be easily positioned with respect to the case, which makes it possible to easily bond the terminal electrodes and the bus bars to each other.

In the capacitor module in a third exemplary aspect, the second recess and the third recess may be arranged continuously with the first recess, and the second recess and the third recess may be spaced apart from each other.

With this configuration, insulation can be secured between the first terminal electrode and the second terminal electrode.

In the capacitor module in a fourth exemplary aspect, in the case, the first recesses may be aligned in a first direction, and the second recesses and the third recesses may be alternately aligned in the first direction.

With this configuration, the space in the case can be effectively utilized, which contributes to downsizing of the capacitor module.

In the capacitor module in a fifth exemplary aspect, the case may include a first case incorporating the first bus bar, and a second case incorporating the second bus bar.

With this configuration, a capacitor module having a smaller size can be provided.

In the capacitor module in a sixth exemplary aspect, the first connection portions may be disposed in an outer side surface of the first case, and the second connection portions may be disposed in an outer side surface of the second case. Moreover, the first terminal electrode may include a first extending portion extending from the capacitor toward the outer side surface of the first case, and a first bend that is bent from the first extending portion along the outer side surface of the first case, and the second terminal electrode may include a second extending portion extending from the capacitor toward the outer side surface of the second case, and a second bend that is bent from the second extending portion along the outer side surface of the second case.

With this configuration, the terminal electrodes and the bus bars are connected to each other in the outer side surface of the case, which enables the capacitor module to have a smaller size.

In the capacitor module in a seventh exemplary aspect, the first case and the second case may have a same shape, and the first bus bar and the second bus bar may have a same shape.

With this configuration, the number of components can be reduced, thereby reducing the fabrication cost.

In the capacitor module in an eighth exemplary aspect, the first case may be provided, in the outer side surface, with an opening for exposing the first connection portion(s), and the second case may be provided, in the outer side surface, with an opening for exposing the second connection portion(s).

With this configuration, the size of the capacitor module can be reduced, and the terminal electrodes can e easily bonded to the bus bars.

In another exemplary aspect, a method is provided for fabricating a capacitor module that includes preparing a case integrally incorporating a first bus bar and a second bus bar, the case being provided with a recess for housing a capacitor having a first terminal electrode and a second terminal electrode; disposing the capacitor in the recess in the case; and connecting the first bus bar to the first terminal electrode, and connecting the second bus bar to the second terminal electrode.

With this configuration, the terminal electrodes can be easily bonded to the bus bars.

In yet another exemplary aspect, a method is provided for fabricating a capacitor module that includes preparing a first case integrally incorporating a first bus bar and provided with a recess for housing a capacitor having a first terminal electrode and a second terminal electrode; preparing a second case integrally incorporating a second bus bar and provided with a recess for housing the capacitor; disposing the capacitor in the recess provided in the first case; bending the first terminal electrode and the second terminal electrode; overlaying the second case on the first case; connecting the first terminal electrode to the first bus bar; and connecting the second terminal electrode to the second bus bar.

With this configuration, positioning in assembling the capacitor module can be easily performed, which enables easily bonding the terminal electrodes and the bus bars to each other.

Hereinafter, exemplary embodiments will be described with reference to the accompanying drawings. Incidentally, in the respective drawings, respective components are exaggerated in order to facilitate the description.

### First Exemplary Embodiment

### [Overall Configuration]

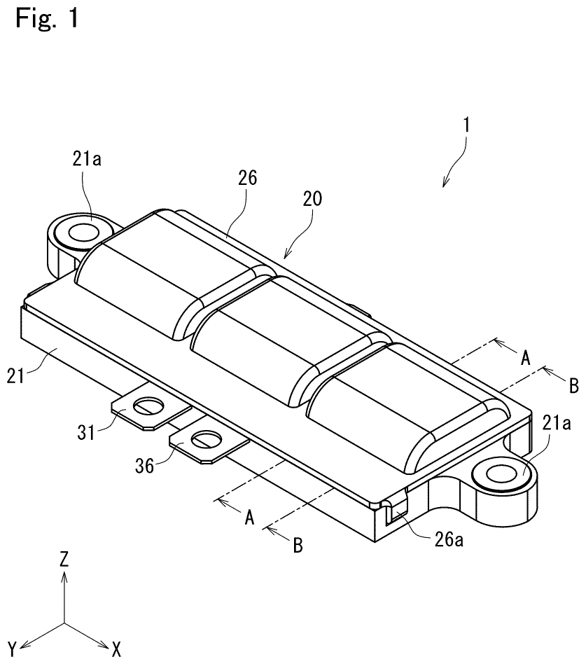

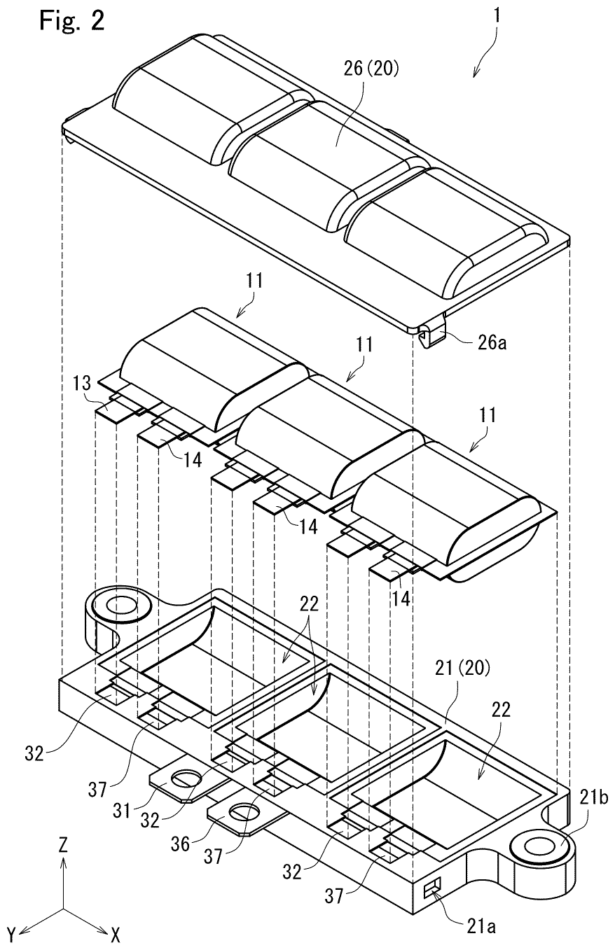

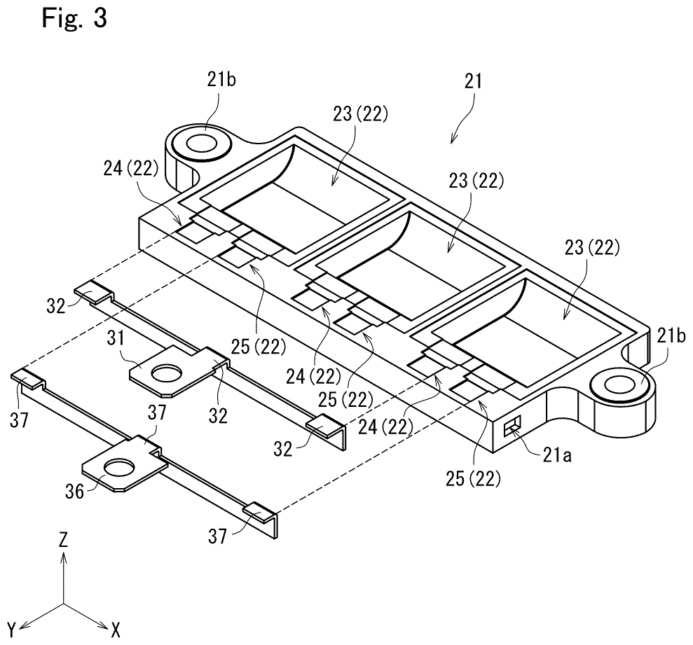

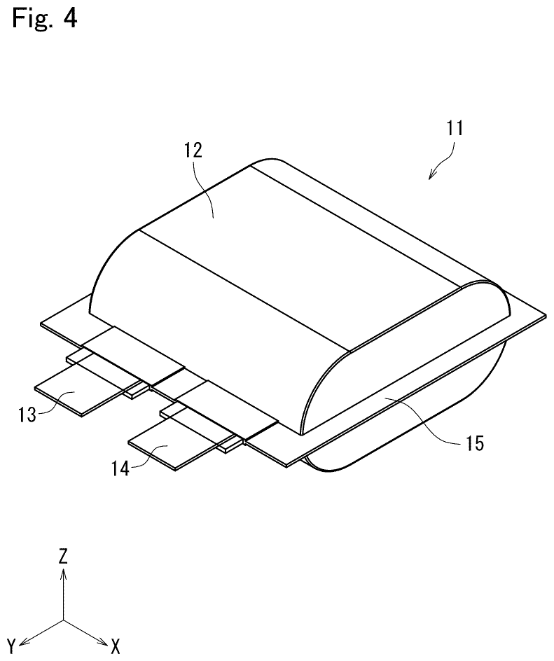

FIG. 1 is a perspective view illustrating a capacitor module according to a first exemplary embodiment. FIG. 2 is an exploded perspective view of the capacitor module in FIG. 1. FIG. 3 is an exploded view of a first case 21 in the capacitor module in FIG. 1. FIG. 4 is a perspective view illustrating a capacitor 11 in the capacitor module in FIG. 1. For purposes of this disclosure, it is noted that X, Y, and Z directions in the figures indicate a lateral direction, a longitudinal direction, and a height-wise direction of the capacitor module of the first exemplary embodiment, respectively.

As illustrated in FIGS. 1 to 3, the capacitor module includes a plurality of capacitors 11 (FIG. 2), a case 20, a first bus bar 31 (FIGS. 3 and 2), and a second bus bar 36.

### <Capacitor>

As illustrated in FIG. 4, the capacitor 11 includes a main-body 12, a first terminal electrode 13, and a second terminal electrode 14. The main-body 12 in the capacitor 11 is covered with a laminate film 15.

The capacitor 11 is, for example, a film capacitor formed by a dielectric film that is wound or laminated. In the present embodiment, the capacitor 11 is a columnar film capacitor having an oval cross section. As the dielectric film forming the capacitor 11, a plastic film can be used that is formed from, for example, polyethylene terephthalate, polypropylene, polyphenylene sulfide, or polyethylene naphthalate. As a vapor-deposited metal film formed on the surface of the plastic film, a metal can be used such as aluminum or zinc, for example.

The capacitor 11 includes, on both the end surfaces, end surface electrodes (not illustrated) formed through metal spraying. A first terminal electrode 13 and a second terminal electrode 14 each having a flat plate shape are electrically connected to the respective end surface electrodes.

The first terminal electrode 13 and the second terminal electrode 14 are exposed to the outside of the laminate film 15 from the main-body 12. In the present embodiment, the first terminal electrode 13 and the second terminal electrode 14 are formed to extend outward from a side surface of the main-body 12 having a columnar shape.

The main-body 12 of the capacitor 11 is covered with the laminate film 15, which can secure the humidity resistance of the capacitor 11. As the laminate film 15, a film can be used that is formed by resin films and an aluminum foil that are attached to each other. Specifically, an aluminum laminate film formed by a resin film can be used that has heat-sealability, which is formed from cast polypropylene (CPP) or the like, a resin film having excellent strength that is formed from nylon, polyethylene terephthalate or the like, and an aluminum foil attached therebetween through an adhesive agent or thermocompression bonding. The aluminum layer is excellent in water-vapor barrier property. By covering the main-body 12 with the aluminum laminate film having the aluminum layer, the moisture resistance of the capacitor 11 is improved. It should be appreciated that the effects of the exemplary embodiment are not limited by the materials forming the laminate film, and it is possible to appropriately adopt materials of the laminate film that provide higher adhesiveness between the laminate films and have higher water-vapor barrier properties, strength, or durability.

In the present embodiment, three capacitors 11 are housed in the case 20 according to an exemplary aspect.

### <Case>

The case 20 is a member that houses the capacitors 11. In the present embodiment, the case 20 includes a first case 21 provided with three recesses 22 for housing the capacitors 11, and a second case 26 which covers the first case 21. A first bus bar 31 and a second bus bar 36 are integrally incorporated in the first case 21 in the case 20. The first case 21 corresponds to a main body of the case 20, and the second case 26 corresponds to a lid of the case 20.

In the present embodiment, as illustrated in FIG. 3, each recess 22 in the first case 21 includes a first recess 23, a second recess 24, and a third recess 25. The first recess 23 is a recess for disposing the main-body 12 therein, the second recess 24 is a recess for disposing the first terminal electrode 13 therein, and the third recess 25 is a recess for disposing the second terminal electrode 14 therein.

When the main-body 12 of the capacitor 11 is housed in the first recess 23, the first terminal electrode 13 in the capacitor 11 is disposed in the second recess 24, and the second terminal electrode 14 in the capacitor 11 is disposed in the third recess 25. The first recess 23 and the second recess 24, and the first recess 23 and the third recess 25 are arranged continuously with each other.

In the present embodiment, the first recesses 23 are aligned in a row in the lateral direction (a first direction), in order to enable disposing three capacitors 11 side by side in a row. Further, the second recesses 24 and the third recesses 25 are alternately disposed in the first direction with intervals interposed therebetween.

The second case 26 is a member for covering the first case 21 and housing the capacitors 11 inside the case 20. In the present embodiment, the capacitors 11 can be housed in the case 20 such that the three capacitors 11 are sandwiched between the first case 21 and the second case 26. As illustrated in FIG. 2, the second case 26 is provided with a hook 26a, while the first case 21 is provided with a recess 21a. By engaging the hook 26a with the recess 21a, the second case 26 can be fixed to the first case 21. The fixing the first case 21 and the second case 26 to each other is not limited to the hook and may be performed through arbitrary means such as fastening the first case 21 and the second case 26 to each other with a screw, for example.

In the present embodiment, the first case 21 is provided, on its outer side surface, with fixing portions 21b for fixing the capacitor module to an external substrate, device, or the like. For example, by fastening a screw or the like to the fixing portions 21b, the capacitor module can be fixed to an external substrate, device, or the like.

As a material forming the first case 21 and the second case 26, a synthetic resin can be used such as polyphenylene sulfide, polybutylene terephthalate, or a liquid crystal polymer, for example. It is preferable that glass fibers or inorganic fillers are blended in these materials in order to improve the dimensional stability or the strength according to an exemplary aspect.

### <Bus Bars>

The first bus bar 31 is connected to the first terminal electrodes 13 in the capacitors 11. The second bus bar 36 is connected to the second terminal electrodes 14 in the capacitors 11. The first bus bar 31 and the second bus bar 36 are connected to, for example, electrodes (not illustrated) on an external substrate, device, or the like, thereby electrically connecting the capacitors 11 to the external substrate, device, or the like. As illustrated in FIG. 2, the first bus bar 31 and the second bus bar 36 are integrally incorporated in the first case 21 by, for example, insert molding, and are partially exposed from the first case 21. The first bus bar 31 and the second bus bar 36 are separated from each other by the resin forming the first case 21.

The first bus bar 31 and the second bus bar 36 are formed from, for example, a plate-shaped conductive member made of copper, brass, aluminum, or the like. Among them, it is preferable to use oxygen-free copper or pure copper called tough pitch copper, which has excellent conductivity. The first bus bar 31 and the second bus bar 36 may have a metal film formed from nickel, tin, or the like on their surfaces through plating or the like.

As illustrated in FIGS. 2 and 3, the first bus bar 31 has first connection portions 32 connected to the first terminal electrodes 13. The first connection portions 32 are exposed from the first case 21 so as to be positioned in the second recesses 24. The second bus bar 36 has second connection portions 37 connected to the second terminal electrodes 14. The second connection portions 37 are exposed from the first case 21 so as to be positioned in the third recesses 25.

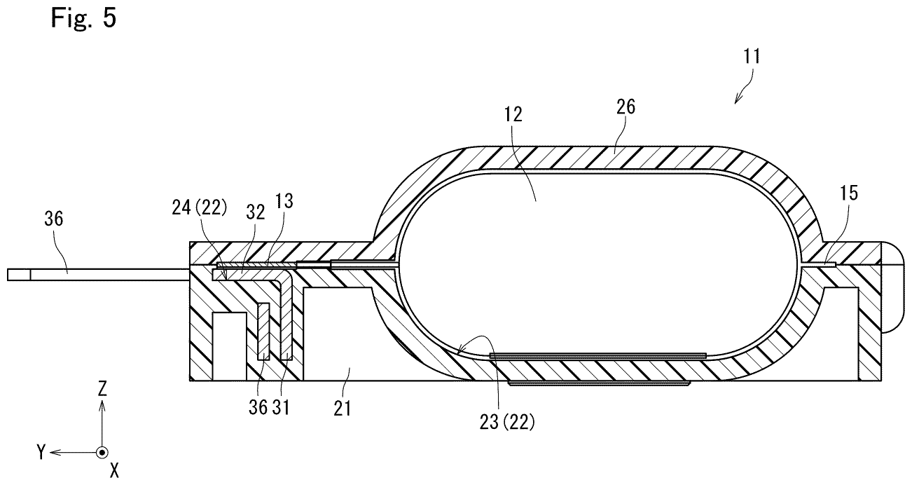

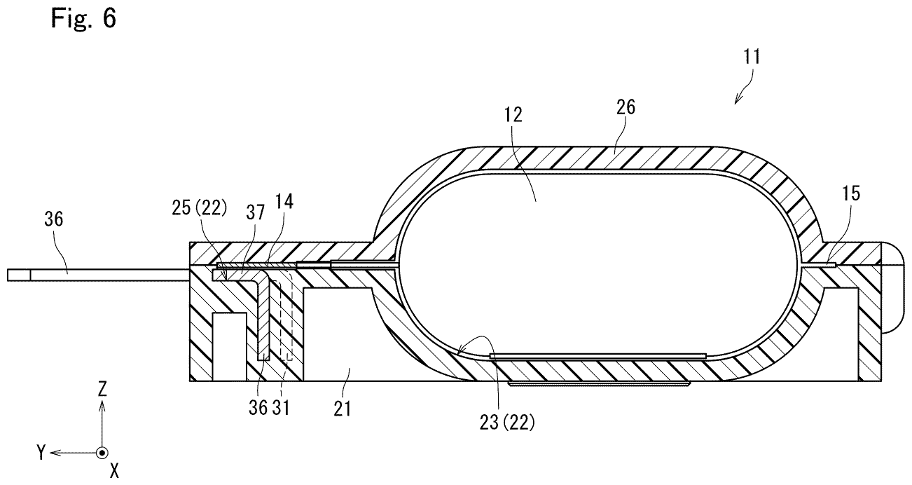

FIG. 5 is a cross-sectional view of the capacitor module taken along a line A-A in FIG. 1. FIG. 6 is a cross-sectional view of the capacitor module taken along a line B-B in FIG. 1.

As illustrated in FIG. 5, when the main-bodies 12 of the capacitors 11 have been housed in the recesses 22 in the first case 21, the first terminal electrodes 13 are housed in the second recesses 24, and the first terminal electrodes 13 are disposed on the first connection portions 32 of the first bus bar 31. Namely, the first terminal electrodes 13 and the first connection portions 32 are overlaid and contacted on and with each other in the height-wise direction (the Z direction). Therefore, by disposing the main-bodies 12 of the capacitors 11 in the first recesses 23 (the recesses 22), the first terminal electrodes 13 can be positioned on the first connection portions 32 of the first bus bar 31. The first terminal electrodes 13 are positioned by the second recesses 24. The first terminal electrodes 13 and the first connection portions 32 of the first bus bar 31 are electrically connected to each other by, for example, ultrasonic welding.

Similarly, as illustrated in FIG. 6, when the main-bodies 12 of the capacitors 11 have been housed in the recesses 22 in the first case 21, the second terminal electrodes 14 are housed in the third recesses 25, and the second terminal electrodes 14 are disposed on the second connection portions 37 of the second bus bar 36. Namely, the second terminal electrodes 14 and the second connection portions 37 are overlaid and contacted on and with each other in the height-wise direction (the Z direction). Therefore, by disposing the capacitors 11 in the recesses 22, the second terminal electrodes 14 can be positioned on the second connection portions 37 of the second bus bar 36. The second terminal electrodes 14 are positioned by the third recesses 25. Similarly, the second connection portions 37 of the second bus bar 36 and the second terminal electrodes 14 are electrically connected to each other by, for example, ultrasonic welding.

It is possible to position the terminal electrodes 13, 14 by housing the capacitors 11 in the recesses 22. This can improve the workability during the ultrasonic welding.

As illustrated in FIGS. 5 and 6, the first bus bar 31 and the second bus bar 36 are isolated from each other within the first case 21, by the resin forming the first case 21. This can secure the insulation between the first bus bar 31 and the second bus bar 36.

### [Fabricating Method]

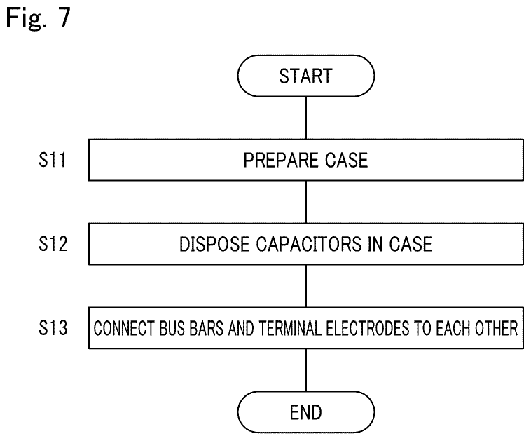

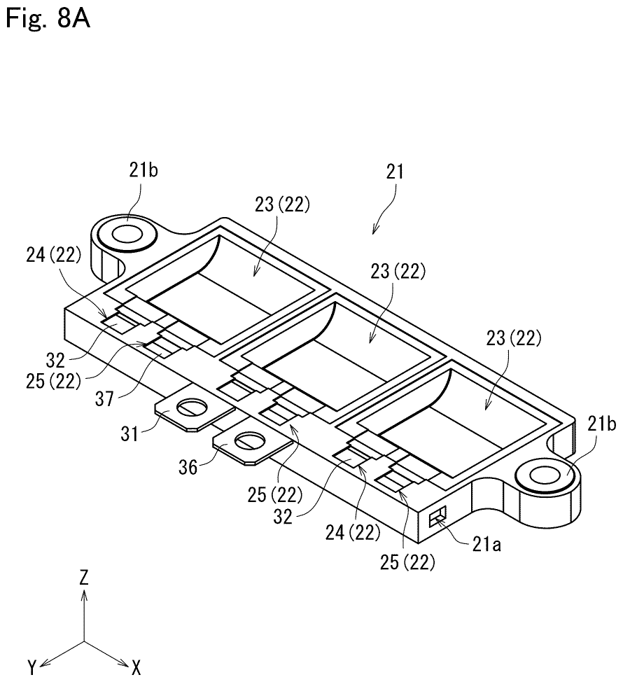

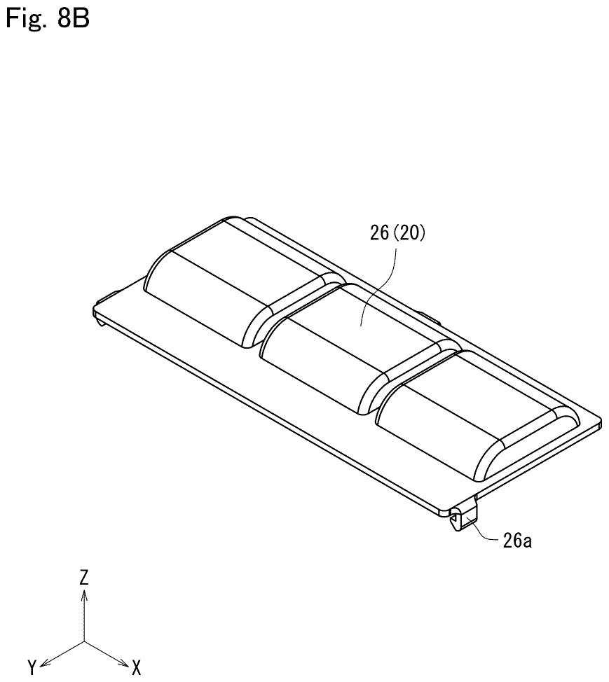

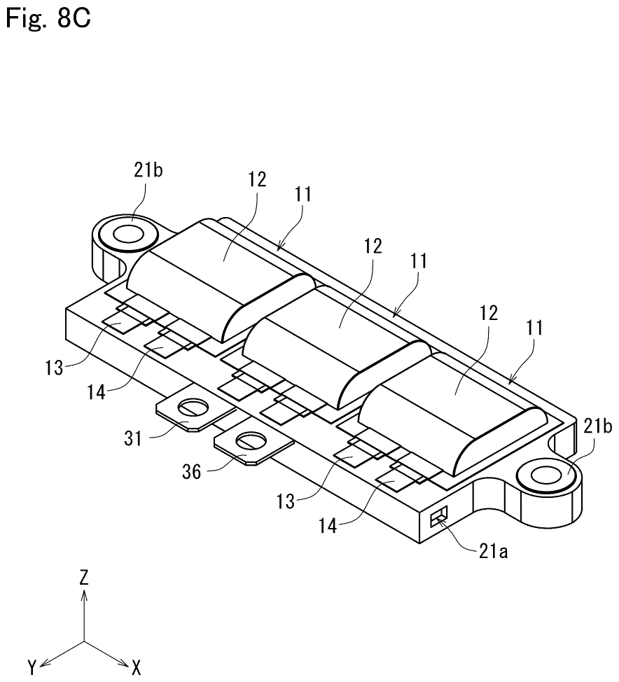

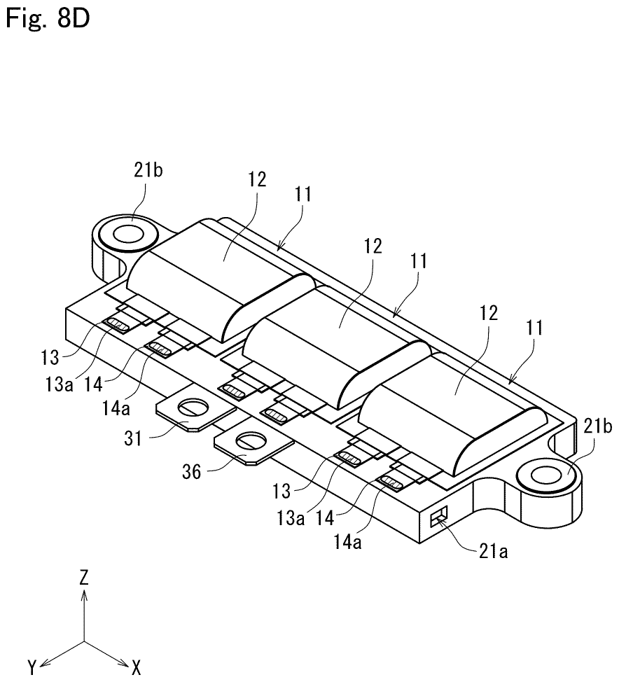

FIG. 7 is a flowchart illustrating a method for fabricating the capacitor module according to the first exemplary embodiment. FIGS. 8A to 8D are views illustrating an example of processes for fabricating the capacitor module according to the first exemplary embodiment. A method for fabricating the capacitor module according to the first exemplary embodiment will be described with reference to FIGS. 7 to 8D.

First, as illustrated in FIGS. 8A and 8B, the case 20 is prepared (a step S11). In the present embodiment, in the step S11, the first case 21 and the second case 26 are formed. The first case 21 can be formed integrally with the first bus bar 31 and the second bus bar 36 by, for example, insert molding. The three recesses 22 (the first recesses 23, the second recesses 24, and the third recesses 25) are formed in the first case 21. Further, in the first case 21, the first connection portions 32 of the first bus bar 31 are disposed in the second recesses 24, and the second connection portions 37 of the second bus bar 36 are disposed in the third recesses 25. At this time, the first connection portions 32 of the first bus bar 31 are exposed through the second recesses 24 in the first case 21, and the second connection portions 37 of the second bus bar 36 are exposed through the third recesses 25 in the first case 21. The second case 26 can be formed by, for example, injection molding.

Next, as illustrated in FIG. 8C, the capacitors 11 are disposed in the respective three recesses 22 in the first case 21 (step S12). By disposing the respective capacitors 11 in the recesses 22, the first terminal electrodes 13 are overlaid on the first connection portions 32 in the height-wise direction, and the second terminal electrodes 14 are overlaid on the second connection portions 37 in the height-wise direction. When disposing the capacitors 11 in the first case 21, it is also possible to use an adhesive agent or the like.

Next, as illustrated in FIG. 8D, the first bus bar 31 and the first terminal electrodes 13 are connected to each other, and the second bus bar 36 and the second terminal electrodes 14 are connected to each other (step S13). The first connection portions 32 and the first terminal electrodes 13 are welded to each other by, for example, applying an ultrasonic vibration to the portions of the first connection portions 32 of the first bus bar 31 and the first terminal electrodes 13 which are overlaid on each other. As a result of the ultrasonic welding, first welded portions 13a are formed. Similarly, the second connection portions 37 and the second terminal electrodes 14 are welded to each other by, for example, applying an ultrasonic vibration to the portions of the second connection portions 37 of the second bus bar 36 and the second terminal electrodes 14 which are overlaid on each other. As a result of the ultrasonic welding, second welded portions 14a are formed. The connection portions 32 and 37 and the terminal electrodes 13 and 14 are electrically connected to each other by the welding.

The second case 26 is attached to the first case 21 to complete the capacitor module according to the first exemplary embodiment.

### Technical Effects

The capacitor module according to the first exemplary embodiment and the method for fabricating the capacitor module according to the first embodiment can achieve the following effects.

The capacitor module according to the first exemplary embodiment includes the three capacitors 11, the case 20, the first bus bar 31, and the second bus bar 36. Each capacitor 11 includes the main-body 12 covered with the laminate film 15, and the first terminal electrode 13 and the second terminal electrode 14 exposed from the main-body 12. The case 20 houses the capacitors 11. The case 20 is provided with the three recesses 22 which house the respective capacitors 11. The first bus bar 31 is integrally incorporated in the case 20 and has the first connection portions 32 electrically connected to the first terminal electrodes 13. The second bus bar 36 is integrally incorporated in the case 20 and has the second connection portions 37 electrically connected to the second terminal electrodes 14.

With this configuration, it is possible to secure insulation between the bus bars 31, 36, which enables provision of the exemplary capacitor module with improved insulation. In addition, since the bus bars 31, 36 are integrally incorporated in the first case 21 (the case 20), it is possible to provide the exemplary capacitor module with a reduced size.

Each recess 22 includes the first recess 23, the second recess 24, and the third recess 25. The main-body 12 of the capacitor 11 is disposed in the first recess 23. The first terminal electrode 13 in the capacitor 11 is disposed in the second recess 24. The second terminal electrode 14 in the capacitor 11 is disposed in the third recess 25. The first connection portions 32 of the first bus bar 31 are positioned in the second recesses 24. The second connection portions 37 of the second bus bar 36 are positioned in the third recesses 25.

With this configuration, it is possible to easily bond the terminal electrodes 13, 14 in the capacitors 11 to the bus bars 31, 36.

The second recess 24 and the third recess 25 are arranged continuously with the first recess 23. The second recess 24 and the third recess 25 are spaced apart from each other.

With this configuration, it is possible to secure insulation between the first terminal electrode 13 and the second terminal electrode 14 in the capacitor 11.

In the first case 21 in the case 20, the first recesses 23 are aligned in the first direction (the X direction), and the second recesses 24 and the third recesses 25 are alternately aligned in the first direction.

With this configuration, it is possible to effectively utilize the space in the case 20, which contributes to downsizing of the capacitor module according to the first exemplary embodiment.

The method for fabricating the capacitor module according to the first exemplary embodiment includes forming the case 20; disposing the capacitors 11 in the case 20; and connecting the bus bars 31, 36 and the terminal electrodes 13, 14 to each other.

With this method, it is possible to easily attain positioning in assembling the capacitor module according to the first exemplary embodiment, which makes it possible to easily bond the terminal electrodes 13 and 14 and the bus bars 31 and 36 to each other.

Although in the aforementioned embodiment, there has been described an example where the exemplary capacitor module includes three capacitors 11, the exemplary embodiments are not limited thereto. The capacitor module according to the first exemplary embodiment can include one or more capacitors 11 in alternative embodiments.

In the aforementioned embodiment, there has been described an example where the capacitor 11 is formed to have a columnar shape having an oval cross section. However, the capacitor 11 may be also formed to have a circular column shape in another exemplary embodiment. Also, the capacitor 11 may be a wound film capacitor or a laminated film capacitor, for example.

Further, in the aforementioned embodiment, there has been described an example where the capacitor 11 includes one first terminal electrode 13 and one second terminal electrode 14. However, the capacitor 11 may have a plurality of first terminal electrodes 13 and a plurality of second terminal electrodes 14 in alternative aspects. Also, the capacitor 11 may have a metal terminal that is not connected to the end surface electrodes and is exposed from the main-body 12. In this case, the capacitor module has improved heat dissipation. In the case of providing the metal terminal, the case can be provided with a recess for disposing and positioning the metal terminal.

Further, in the aforementioned embodiment, there has been described an example where the bus bars 31 and 36 and the terminal electrodes 13 and 14 are bonded to each other by ultrasonic welding. However, the bus bars 31 and 36 and the terminal electrodes 13 and 14 can be electrically connected to each other by, for example, solder bonding, resistance welding, laser welding, or the like in alternative aspects.

Further, in the aforementioned embodiment, there has been described an example where the first case 21 and the second case 26 are fixed to each other by the hook 26a provided in the second case 26 and the recess 21a provided in the first case 21. However, the first case 21 and the second case 26 can be fixed to each other by, for example, a screw or an adhesive agent in an alternative aspect.

Also, it is possible to dispose a thermal pad or the like having high thermal conductivity and flexibility between the capacitors 11 and the case 20. By disposing such a thermal pad or the like, it is possible to improve the heat dissipation of the exemplary capacitor module. Further, since the thermal pad has flexibility, the thermal pad can absorb impacts on the capacitors 11, which can improve the durability of the capacitor module according to the first exemplary embodiment.

### Second Exemplary Embodiment

A capacitor module according to a second exemplary embodiment will be described.

In the second embodiment, differences from the first embodiment will be mainly described. In the second embodiment, the same or equivalent configurations as or to those of the first embodiment will be described with the same reference numerals. Further, in the second embodiment, description overlapping with that of the first embodiment will be omitted.

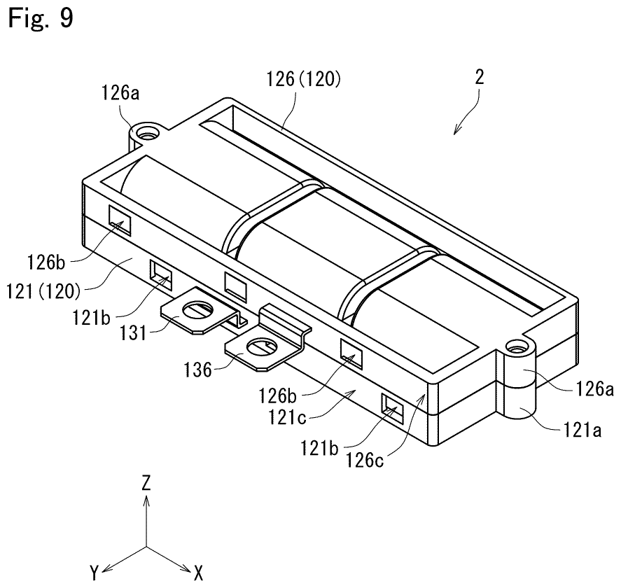

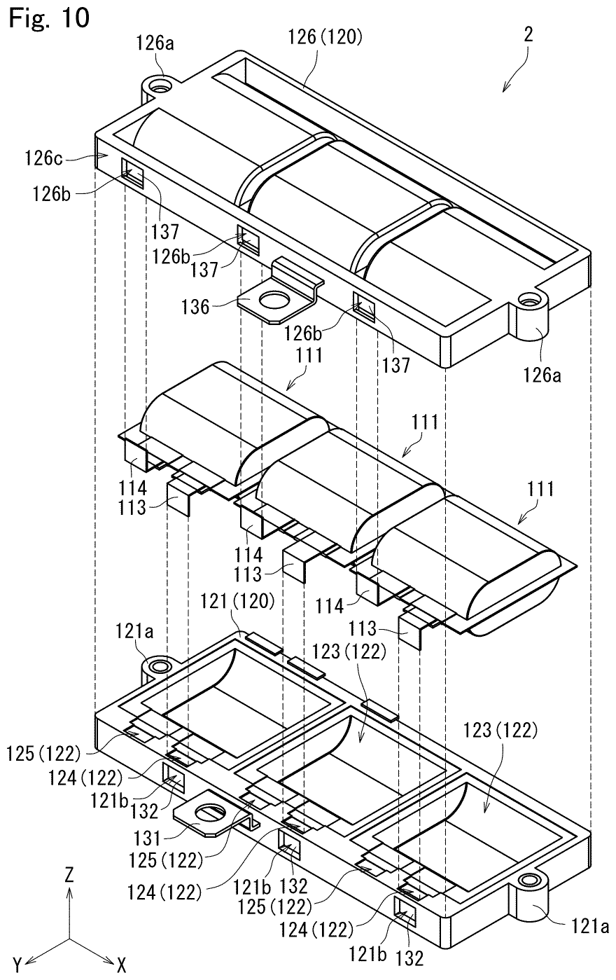

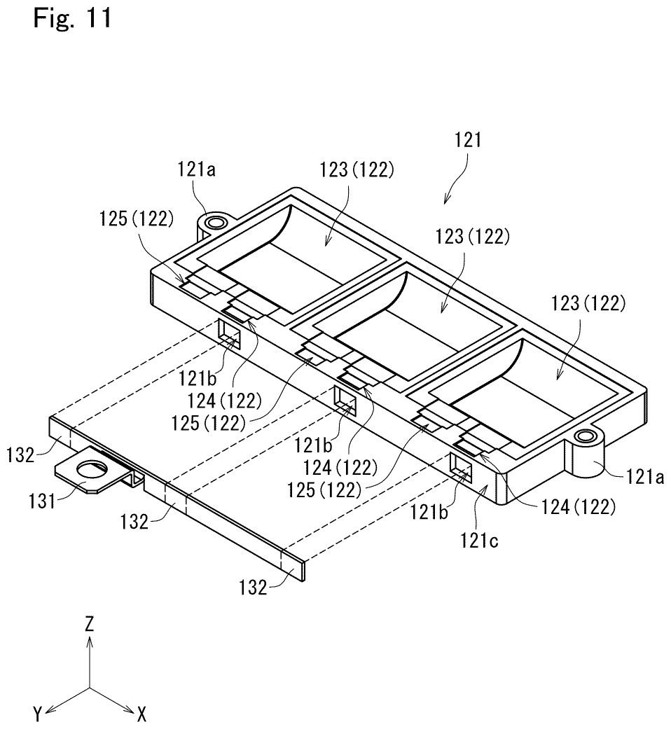

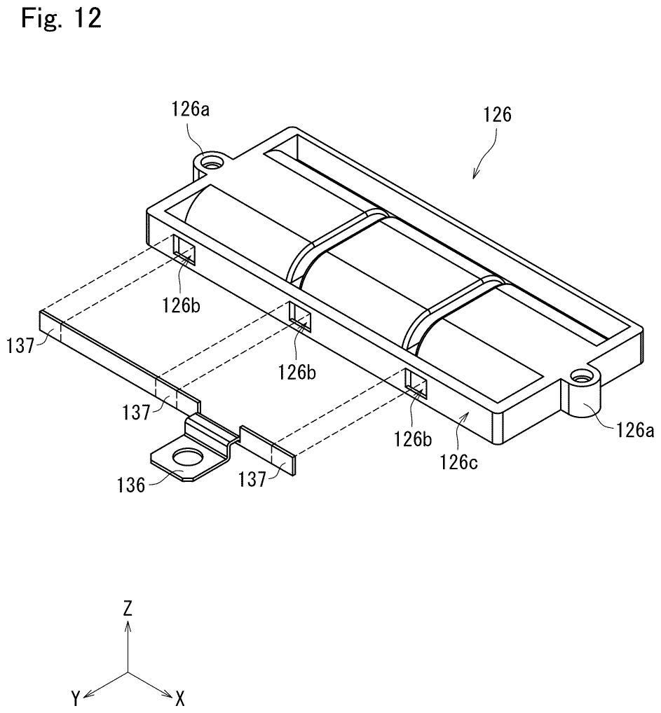

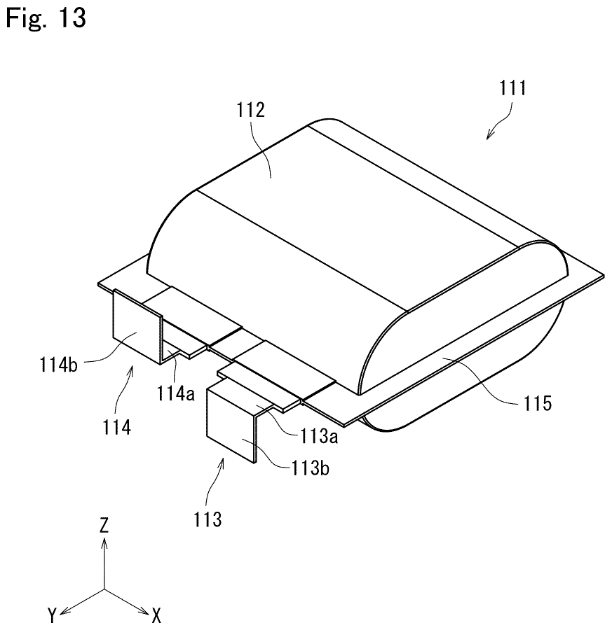

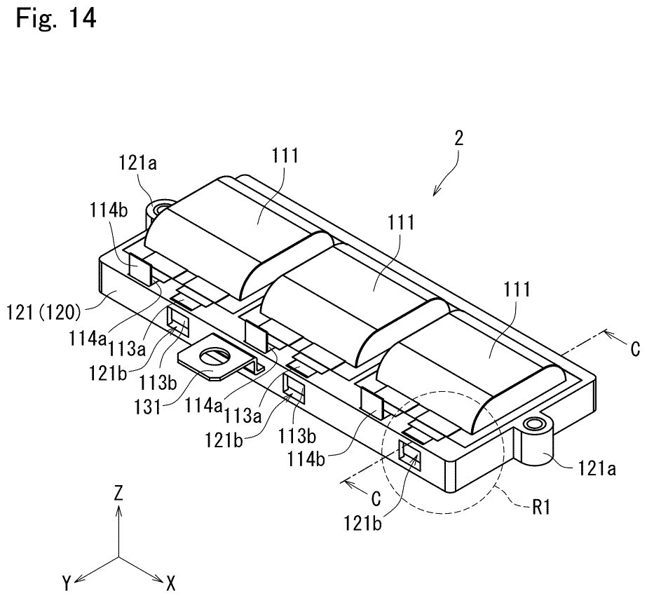

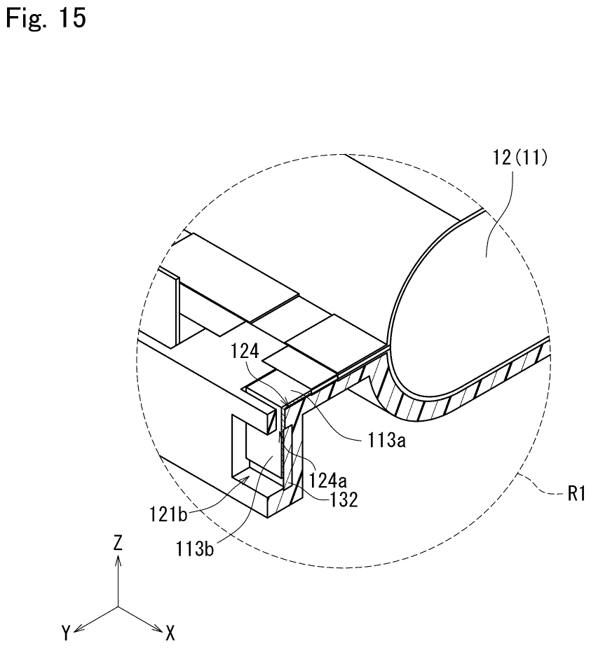

FIG. 9 is a perspective view illustrating the capacitor module according to the second exemplary embodiment. FIG. 10 is an exploded perspective view of the capacitor module in FIG. 9. FIG. 11 is an exploded view of a first case 121 in the capacitor module in FIG. 9. FIG. 12 is an exploded view of a second case 126 in the capacitor module in FIG. 9. FIG. 13 is a perspective view illustrating a capacitor 111 in the capacitor module in FIG. 9. FIG. 14 is a view of the capacitor module in FIG. 9, wherein the second case 126 is omitted. FIG. 15 is an enlarged cross-sectional view of a region RI taken along a line C-C in FIG. 14.

The second embodiment is different from the first embodiment in that a case 120 includes a first case 121 and a second case 126, the first case 121 incorporates a first bus bar 131, and the second case 126 incorporates a second bus bar 136. Namely, the second embodiment is different from the first embodiment in that the two bus bars 131, 136 are not incorporated in one case, out of the two separated cases 120, but the bus bars 131, 136 are separately incorporated in the respective cases.

Further, the second embodiment is different from the first embodiment in that first connection portions 132 of the first bus bar 131 are positioned in the outer side surface of the first case 121, and second connection portions 137 of the second bus bar 136 are positioned in the outer side surface of the second case 126. Namely, the second embodiment is different from the first embodiment in that the portions of the bus bars 131, 136 and capacitors 111, which are connected to each other are not provided inside the case 120 but are exposed through the outer side surface of the case 120.

Further, the second embodiment is different from the first embodiment in that a first terminal electrode 113 and a second terminal electrode 114 of the capacitor 111 have extending portions 113a, 114a and bends 113b, 114b. Namely, the second embodiment is different from the first embodiment in that the terminal electrodes 113 and 114 are bent, rather than being extended in one direction.

As illustrated in FIGS. 9 to 12, in the present embodiment, the case 120 in the exemplary capacitor module includes the first case 121 and the second case 126. The first bus bar 131 is integrally incorporated in the first case 121 (FIG. 11), and the second bus bar 136 is integrally incorporated in the second case 126 (FIG. 12). In the present embodiment, the first case 121 and the second case 126 are fixed to each other by fastening screws or the like to fixing portions 121a, 126a provided on the respective cases. Further, the fixing portions 121a, 126a can also be used for fixing the exemplary capacitor module to an external substrate, device, or the like. In the present embodiment, the first case 121 and the second case 126 have the same shape, and the first bus bar 131 and the second bus bar 136 have the same shape.

As further shown, the first case 121 is provided with recesses 122, similarly to in the first embodiment. Specifically, each recess 122 includes a first recess 123, a second recess 124, and a third recess 125. The first recess 123 and the second recess 124 are continuously arranged, and the first recess 123 and the third recess 125 are continuously arranged. Similarly, the second case 126 is provided with first recesses, second recesses, and third recesses.

In the present embodiment, the first case 121 is provided, in an outer side surface 121c thereof, with openings 121b. Similarly, the second case 126 is provided, in an outer side surface 126c thereof, with openings 126b. The first connection portions 132 of the first bus bar 131 are positioned in the openings 121b in the first case 121. Similarly, the second connection portions 137 of the second bus bar 136 are positioned in the openings 126b in the second case 126.

As illustrated in FIG. 13, the first terminal electrode 113 in the capacitor 111 has a first extending portion 113a extending from the main-body 112 of the capacitor 111 toward the outer side surface 121c of the first case 121, and a first bend 113b bent from the first extending portion 113a along the outer side surface 121c of the first case 121. The second terminal electrode 114 in the capacitor 111 has a second extending portion 114a extending from the main-body 112 of the capacitor 111 toward the outer side surface 126c of the second case 126, and a second bend 114b bent from the second extending portion 114a along the outer side surface 126c of the second case 126. The first bend 113b of the first terminal electrode 113 and the second bend 114b of the second terminal electrode 114 extend in opposite directions. Namely, the first extending portion 113a of the first terminal electrode 113 extends in the downward direction (−Z direction), while the second extending portion 114a of the second terminal electrode 114 extends in the upward direction (+Z direction).

As illustrated in FIGS. 14 and 15, the openings 121b in the first case 121 communicate with the second recesses 124 through slits 124a. By inserting the first bend 113b of the first terminal electrode 113 into the slit 124a, the first connection portion 132 of the first bus bar 131 and the first bend 113b of the first terminal electrode 113 can be overlaid on each other in the longitudinal direction (Y direction) in the opening 121b. The first terminal electrode 113 and the first bus bar 131 can be electrically connected to each other by bonding the portions of the first connection portion 132 and the first bend 113b which are overlaid on each other, by ultrasonic welding, through the opening 121b, for example. The second terminal electrode 114 and the second bus bar 136 are also electrically connected to each other in the same manner. In the second case 126, the openings 126b communicate, through slits, with the third recesses (not illustrated) for disposing the second terminal electrodes 114 therein.

### [Fabricating Method]

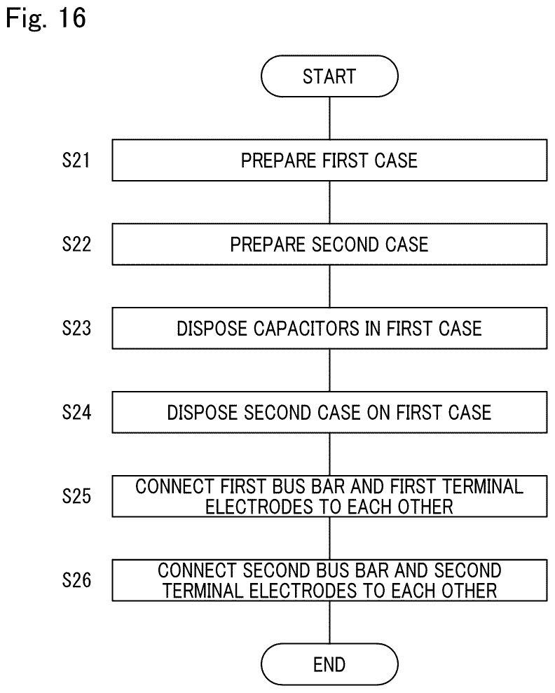

FIG. 16 is a flowchart illustrating a method for fabricating the capacitor module in the exemplary embodiment shown in FIG. 9. The method for fabricating the capacitor module will be described with reference to FIG. 16.

First, the first case 121 is prepared (step S21). The first case 121 can be formed by, for example, insert molding. The first case 121 is provided with recesses 122 for housing the capacitors 111. As illustrated in FIG. 11, each recess 122 includes a first recess 123, a second recess 124, and a third recess 125.

Next, the second case 126 is prepared (step S22). The second case 126 can be formed by, for example, insert molding. Similarly to the first case 121, the second case 126 is provided with recesses.

In the present embodiment, the first case 121 and the second case 126 have the same shape and, therefore, the first case 121 and the second case 126 can be formed using the same mold.

Next, the capacitors 111 are disposed in the recesses 122 in the first case 121 (step S23). At this time, the tip end of each first terminal electrode 113 is bent to form the first bend 113b in advance. Similarly, the tip end of each second terminal electrode 114 is bent to form the second bend 114b in advance. By disposing the main-bodies 112 of the capacitors 111 in the recesses 122 in the first case 121, the first bends 113b are inserted into the slits 124a.

After the capacitors 111 are disposed in the first case 121, the second case 126 is overlaid on and fixed to the first case 121 (step S24). At this time, the second bends 114b are inserted into the slits in the second case 126.

Next, the first bus bar 131 and the first terminal electrodes 113 are connected to each other (step S25). Similarly, the second bus bar 136 and the second terminal electrodes 114 are connected to each other (step S26). By forming the first bends 113b and the second bends 114b, the terminal electrodes 113 and 114 and the bus bars 131 and 136 are disposed so as to be overlaid on each other in the longitudinal direction (Y direction). This makes it possible to easily bond the terminal electrodes 113 and 114 and the bus bars 131 and 136 to each other by welding, for example.

The bus bars 131 and 136 and the terminal electrodes 113 and 114 can be connected to each other by, for example, ultrasonic welding. The bus bars 131 and 136 and the terminal electrodes 113 and 114 are connected to each other to complete the capacitor module of the exemplary embodiment.

### Technical Effects

The capacitor module according to the second exemplary embodiment can achieve the following effects.

In the capacitor module of the second exemplary embodiment, the case 120 includes the first case 121 and the second case 126. The first case 121 incorporates the first bus bar 131. The second case 126 incorporates the second bus bar 136.

With this configuration, the bus bars 131 and 136 are incorporated in the first case 121 and the second case 126, respectively, which enables downsizing in the longitudinal direction (i.e., the Y direction), thereby contributing to size reduction of the capacitor module of the second exemplary embodiment, as compared with the first exemplary embodiment.

The first connection portions 132 of the first bus bar 131 are disposed in the outer side surface 121c of the first case 121, and the second connection portions 137 of the second bus bar 136 are disposed in the outer side surface 126c of the second case 126. The first terminal electrode 113 has the first extending portion 113a extending from the capacitor 111 toward the outer side surface 121c of the first case 121, and the first bend 113b bent from the first extending portion 113a along the outer side surface 121c of the first case 121. The second terminal electrode 114 has the second extending portion 114a extending from the capacitor 111 toward the outer side surface 126c of the second case 126, and the second bend 114b bent from the second extending portion 114a along the outer side surface 126c of the second case 126.

Since the terminal electrodes 113 and 114 are bent, it is possible to realize space saving, which contributes to size reduction of the capacitor module of the second exemplary embodiment.

The first case 121 and the second case 126 have the same shape, and the first bus bar 131 and the second bus bar 136 have the same shape.

Since the first case 121 and the second case 126 have the same shape and the first bus bar 131 and the second bus bar 136 have the same shape, it is possible to reduce the number of components and the number of molds for the capacitor module of the second exemplary embodiment, which can reduce the fabrication cost.

The first case 121 is provided, in its outer side surface 121c, with the openings 121b for exposing the first connection portions 132, and the second case 126 is provided, in it's the outer side surface 126c, with the openings 126b for exposing the second connection portions 137.

The terminal electrodes 113 and 114 and the bus bars 131 and 136 can be bonded to each other in the outer side surfaces 121c and 126c of the cases 121 and 126, which enables further reducing the size of the capacitor module of the second exemplary embodiment.

A method for fabricating the capacitor module according to the second exemplary embodiment includes preparing the first case 121; preparing the second case 126; disposing the capacitors 111 in the first case 121; overlaying the second case 126 on the first case 121; and connecting the bus bars 131, 136 and the terminal electrodes 113, 114 to each other.

In assembling the capacitor module of the second exemplary embodiment, the capacitors 111 are positioned by the recesses 122, which facilitates assembling. In addition, since the terminal electrodes 113 and 114 have the bends 113b and 114b, the bends 113b and 114b can be exposed from the outer side surfaces 121c and 126c of the cases 121 and 126, which makes it possible to easily bond the terminal electrodes and the bus bars to each other.

### Modified Example

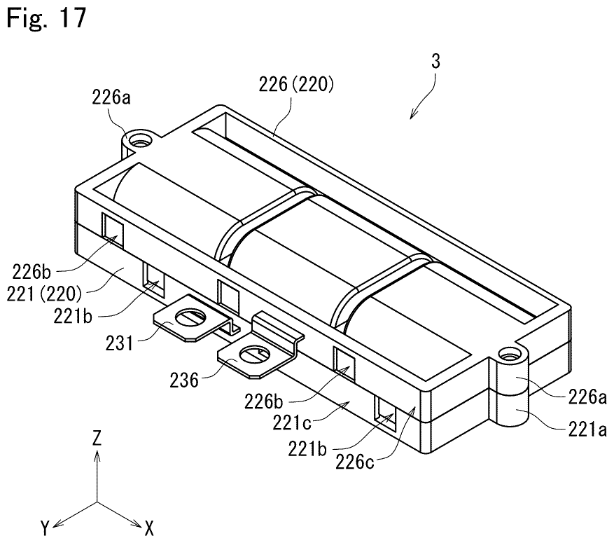

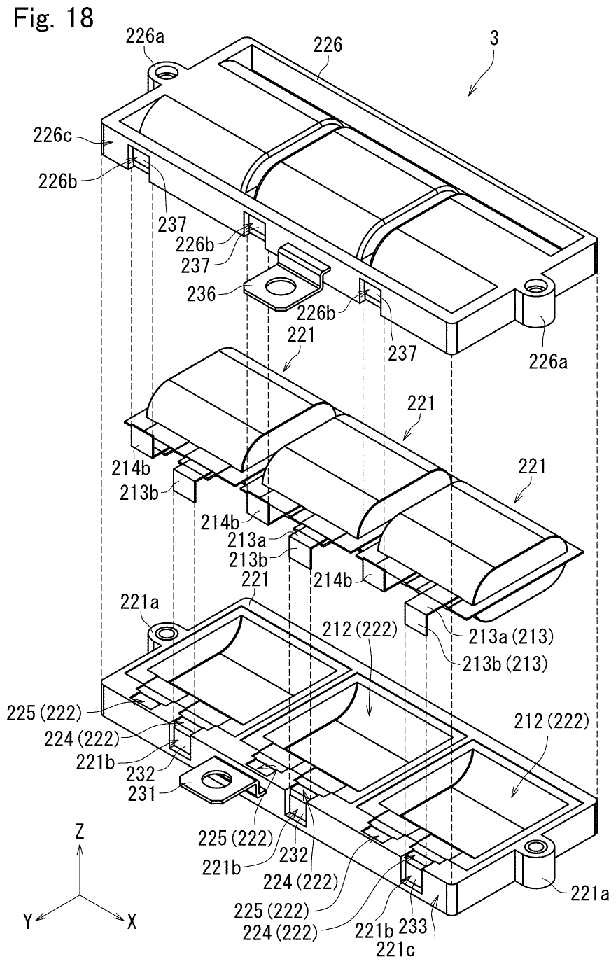

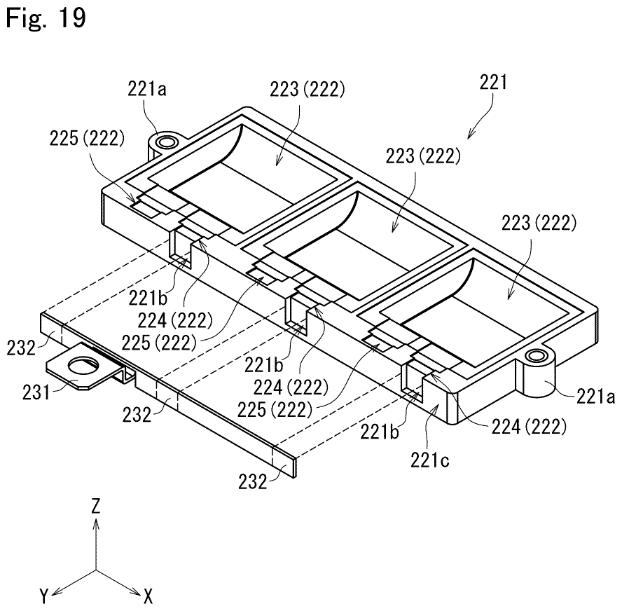

FIG. 17 is a perspective view illustrating a capacitor module in a first modified example according to the second exemplary embodiment. FIG. 18 is an exploded perspective view of the capacitor module in FIG. 17. FIG. 19 is an exploded view of a first case 221 in the capacitor module in FIG. 17.

As illustrated in FIGS. 17 to 19, in the exemplary capacitor module, openings 221b and second recesses 224 in a first case 221 may be continuously formed without slits. In other words, the openings 221b in the first case 221 may be recesses each formed in an outer side surface 221c of the first case 221 and continuous with a first recess 223. In the capacitor module of the present embodiment, a second case 226 has the same shape as that of the first case 221, and the second case 226 is provided with recesses (not illustrated) including first to third recesses, and openings 226b.

Further, first connection portions 232 of a first bus bar 231 are positioned in the openings 221b in the first case 221, and second connection portions 237 of a second bus bar 236 are positioned in the openings 226b in the second case 226.

Further, the first case 221 and the second case 226 can be fixed to each other by, for example, fastening through screws or the like, using fixing portions 221a and 226a provided on the cases 221 and 226, respectively.

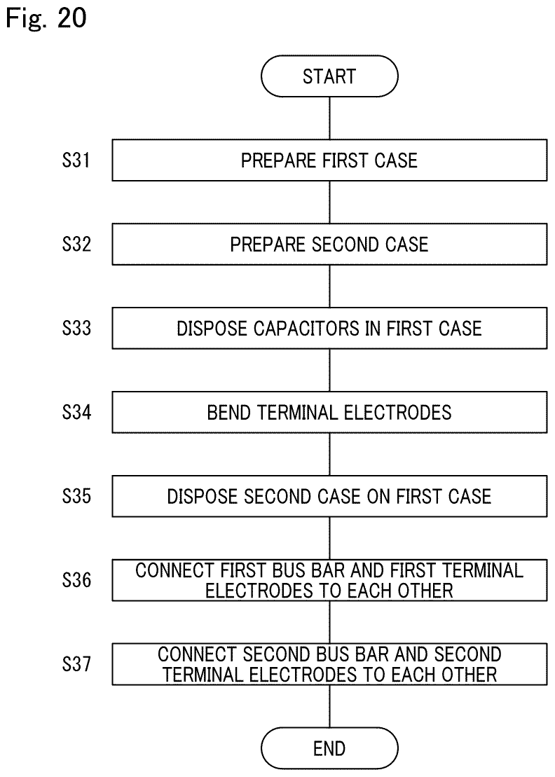

FIG. 20 is a flowchart illustrating a method for fabricating the capacitor module according to the exemplary embodiment shown in FIG. 17. The method for fabricating the capacitor module will be described with reference to FIG. 20. Note that steps S31˜32 and steps S35˜37 are the same as the steps S21˜22, and the steps S24˜26 in FIG. 16, and will not be described.

After the first case 221 and the second case 226 are prepared, capacitors 211 are disposed in the recesses 222 in the first case 221 (step S33). At this time, the capacitors 211 have terminal electrodes having a flat-plate shape as illustrated in FIG. 4. Since the recesses 222 are provided in the first case 221, it is possible to easily perform positioning of the capacitors 211.

Next, the tip end of each first terminal electrode 213 is bent along the outer side surface 221c of the first case 221 to form a first bend 213b, and the tip end of each second terminal electrode 214 is bent along the outer side surface 226c of the second case 226 to form a second bend 214b (step S34).

After the first bends 213b and the second bends 214b are formed, the second case 226 is disposed, and the bus bars 231 and 236 and the terminal electrodes 213 and 214 are connected to each other to complete the capacitor module of the present embodiment (step S5˜37).

Since the openings 221b are arranged continuously with the second recesses 224, the capacitors 211 can be disposed in the recesses 222 in the first case 221, then the bends 213b, 214b can be formed and, thereafter, the second case 226 can be disposed on the first case 221. This makes it easier to assemble the capacitor module of the current exemplary embodiment.

The exemplary embodiments of the present disclosure are applicable to capacitor modules for use in various types of electronic apparatuses, electric apparatuses, industrial apparatuses, vehicle apparatuses, and the like.

### EXPLANATION OF REFERENCES

1, 2, 3 capacitor module
11, 111, 211 capacitor
12, 112 main-body
13, 113, 213 first terminal electrode
14, 114, 214 second terminal electrode
15,115 laminate film
20, 120 case
22, 122, 222 recess
23, 123, 223 first recess
24, 124, 224 second recess
25, 125, 225 third recess
31, 131, 231 first bus bar
32, 132, 232 first connection portion
36, 136, 236 second bus bar
37, 137, 237 second connection portion
113a first extending portion
113b, 213b first bend
114a second extending portion
114b, 214b second bend
121, 221 first case
121b, 121b opening
121c, 221c outer side surface
126, 226 second case
126b, 226b opening
126c, 226c outer side surface

1. A capacitor module comprising:
one or more capacitors that each comprise a main-body covered with a laminate film, and a first terminal electrode and a second terminal electrode exposed from the main-body;
a case including one or more recesses configured to house the one or more capacitors, respectively;
a first bus bar integrally incorporated in the case and electrically connected to the first terminal electrode of each of the one or more capacitors; and
a second bus bar integrally incorporated in the case and electrically connected to the second terminal electrode of each of the one or more capacitors;
wherein the first bus bar includes one or more first connection portions connected to the respective first terminal electrodes of the one or more capacitors disposed in the recesses, respectively, and
wherein the second bus bar includes one or more second connection portions connected to the respective second terminal electrodes of the one or more capacitors disposed in the recesses, respectively.

2. The capacitor module according to claim 1, wherein each of the one or more recesses includes a first recess that accommodates the main-body, a second recess that accommodates the first terminal electrode, and a third recess that accommodates the second terminal electrode.

3. The capacitor module according to claim 2, wherein the one or more first connection portions are positioned in the second recess of the one or more recesses, respectively, and the one or more second connection portions are positioned in the third recess of the one or more recesses, respectively.

4. The capacitor module according to claim 3, wherein, for each of the one or more recesses, the second recess and the third recess are arranged continuously with the first recess, and the second recess and the third recess are spaced apart from each other.

5. The capacitor module according to claim 4, wherein, in the case, the first recess of each of the one or more recesses are aligned in a first direction, and the second recess and the third recess of each of the one or more recesses are alternately aligned in the first direction.

6. The capacitor module according to claim 1, wherein the case includes a first case incorporating the first bus bar, and a second case incorporating the second bus bar.

7. The capacitor module according to claim 6, wherein:
the one or more first connection portions are disposed in an outer side surface of the first case,
the one or more second connection portions are disposed in an outer side surface of the second case.

8. The capacitor module according to claim 7, wherein:
the first terminal electrodes of the one or more capacitors include a first extending portion extending from the respective capacitor towards the outer side surface of the first case, and a first bend that is bent from the first extending portion along the outer side surface of the first case, and
the second terminal electrodes of the one or more capacitors include a second extending portion extending from the respective capacitor towards the outer side surface of the second case, and a second bend that is bent from the second extending portion along the outer side surface of the second case.

9. The capacitor module according to claim 6, wherein the first case and the second case have a same shape, and the first bus bar and the second bus bar have a same shape.

10. The capacitor module according to claim 6, wherein:
the first case is provided, in the outer side surface, with an opening for exposing the one or more first connection portions, and
the second case is provided, in the outer side surface, with an opening for exposing the one or more second connection portions.

11. A capacitor module comprising:
a capacitor that comprises a main-body covered with a laminate film, and a first terminal electrode and a second terminal electrode exposed from the main-body;
a case including a recess that houses the capacitor;
a first bus bar integrally incorporated in the case and electrically connected to the first terminal electrode of the capacitor; and
a second bus bar integrally incorporated in the case and electrically connected to the second terminal electrode of the capacitor,
wherein the first bus bar includes a first connection portion connected to the first terminal electrode of the capacitor disposed in the recess, and
wherein the second bus bar includes a second connection portion connected to the second terminal electrode of the capacitor.

12. The capacitor module according to claim 11, wherein the recess includes a first recess that accommodates the main-body, a second recess that accommodates the first terminal electrode, and a third recess that accommodates the second terminal electrode.

13. The capacitor module according to claim 12, wherein the first connection portion is positioned in the second recess, and the second connection portion is in the third recess.

14. The capacitor module according to claim 13, wherein:
the second recess and the third recess are arranged continuously with the first recess, and the second recess and the third recess are spaced apart from each other, and
the first recess is aligned in a first direction, and the second and third recesses are alternately aligned in the first direction.

15. The capacitor module according to claim 11, wherein the case includes a first case incorporating the first bus bar, and a second case incorporating the second bus bar.

16. The capacitor module according to claim 15, wherein:
the first connection portion is disposed in an outer side surface of the first case, and
the second connection portion is disposed in an outer side surface of the second case.

17. The capacitor module according to claim 16, wherein:
the first terminal electrode includes a first extending portion extending from the capacitor towards the outer side surface of the first case, and a first bend that is bent from the first extending portion along the outer side surface of the first case, and
the second terminal electrode includes a second extending portion extending from the capacitor towards the outer side surface of the second case, and a second bend that is bent from the second extending portion along the outer side surface of the second case.

18. The capacitor module according to claim 15, wherein the first case and the second case have a same shape, and the first bus bar and the second bus bar have a same shape.

19. A method for fabricating a capacitor module, the method comprising:
preparing a case integrally incorporating a first bus bar and a second bus bar, the case comprising a recess for housing a capacitor having a first terminal electrode and a second terminal electrode;
disposing the capacitor in the recess in the case;
connecting the first bus bar to the first terminal electrode; and
connecting the second bus bar to the second terminal electrode.

20. The method for fabricating a capacitor module according to claim 19, wherein:
the preparing of the case comprises preparing a first case integrally incorporating the first bus bar and having a recess for housing the capacitor having the first terminal electrode and a second terminal electrode, and preparing a second case integrally incorporating the second bus bar and having a recess for housing the capacitor;
the disposing of the capacitor in the case comprises disposing the capacitor in the recess of the first case;
the method further comprises bending the first terminal electrode and the second terminal electrode; and overlaying the second case on the first case.
